(19) United States
(12) Patent Application Publication
(10) Pub. No.: US 2002/0092479 A1
(43) Pub. Date: Jul. 18, 2002

(54) Attachable safety device for pets

(76) Inventor: Christine Ann Landenberger, Cypress, CA (US)

Correspondence Address: OPPENHEIMER WOLFF & DONNELLY LLP, 840 NEWPORT CENTER DRIVE, SUITE 700, NEWPORT BEACH, CA, 92660, US

(21) Appl. No.: 10/051,863

(22) Filed: Jan. 16, 2002

Related U.S. Application Data
(60) Provisional application No. 60/261,995, filed on Jan. 16, 2001.

(51) Int. Cl. A62B 35/00

(52) U.S. Cl. 119/858

(57) ABSTRACT

The present invention provides a safety device capable of being easily attached to and removed from the animal's existing collar. The pet's existing collar does not require any modification for use with the present invention, nor are tools required to attach the present invention to the collar. Those skilled in the art will appreciate that the present invention may be constructed of a plurality of materials and may include light reflecting materials, devices, or decorations to enhance animal safety. In addition, the present invention may be capable of being imprinted with or otherwise disposing designs, patterns, messages, slogans, or other decorations as desired.

### CROSS REFERENCE TO RELATED APPLICATIONS

This application claims the benefit of U.S. Provisional Application No. 60/261,995, filed Jan. 16, 2001, naming Chris Landenberger as inventor, and whose entire content is hereby incorporated by reference in its entirety as if fully set forth herein.

### BACKGROUND OF THE INVENTION

Pet owners currently comprise one of the largest and most profitable market segments in the United States. Sixty percent of American households currently own at least one feline or canine, and the combined total number of felines or canines owned exceeds 130 million animals.

Annual revenues associated with the feeding, care, and entertainment of domestic animals are estimated to approach $11 billion and have been growing at approximately 6% per year. Moreover, owners' familial devotion to their household pets results in spending profiles largely price insensitive, irrespective of income levels. As the editor of Dog Fancy magazine commented, “It's not just the wealthy who lavish their pets with attention and expensive toys: it's everyone.” Pet purchases are also largely independent of economic cycles. According to Lynn Moore, Vice President of General Cage, “Pet owners are lavish with their pets . . . they don't stop buying even in a recession.” This spending profile explains why the industry enjoys generous retail margins ranging from 25% to 30% on pet food products, and retail margins from 50% to 60% on toys and accessories.

Pet industry growth has been driven by several demographic trends. The population of the United States is aging, while at the same time, young people are marrying and having children later in life. Both groups eagerly seek companionship, and without the expense of supporting children, they have the financial means to indulge their pets. These trends are expected to continue and the majority of pet retailers and manufacturers are optimistic about future growth.

In view of the foregoing, several safety devices, which assist in visualizing a pet, have developed. Typically, these devices are affixable to the pet or pet's collar. A common safety device currently available comprises a substrate having reflective material attached thereto which is attached to the pet's collar. Usually, the safety device or medallion includes a mechanical fastener, such as a swivel lock, to enable the attachment of the device to the pet's collar. While this device has proven moderately successful in the past, several shortcomings have been identified. For example, visualization of the safety medallion may be easily obscured by the pet's fur. Also, securely attaching the safety medallion to the pet's collar has proven problematic in the past. Often, the safety medallion detaches from the pet's collar unintentionally.

Thus, there is currently a need for a safety device capable of being affixed to a pet and capable of enhancing the visualization thereof.

### BRIEF SUMMARY OF THE INVENTION

The present invention provides a safety device capable of being easily attached to and removed from the animal's existing collar. The pet's existing collar does not require any modification for use with the present invention, nor are tools required to attach the present invention to the collar. Those skilled in the art will appreciate that the present invention may be constructed of a plurality of materials and may include light reflecting materials, devices, or decorations to enhance animal safety. In addition, the present invention may be capable of being imprinted with or otherwise disposing designs, patterns, messages, slogans, or other decorations as desired.

The present invention may be manufactured from a variety of materials, and may be detachably connected to the existing collar using a plurality of techniques. Additionally, the present invention may be utilized as a promotional item by including an advertiser's message or logo to the material in a variety of manners, including, printing, permanent dying, embroidering, stamping, air brushing, or sewing.

In one embodiment, the present invention provides an attachable safety device capable of attaching to the collar of a pet and comprises a body member, at least one attachment mechanism in communication with the body member, and at least one attachment device in communication with the at least one attachment mechanism.

In another embodiment, the present invention is directed to an attachable safety device for pets and includes a body member capable of receiving a design thereon, at least one attachment mechanism in communication with the body member, and at least one attachment device in communication with the at least one attachment mechanism.

The present invention further discloses a method of using the present invention and comprises positioning a collar on said pet, providing a safety device having a body member, at least one attachment mechanism in communication with the body member, and at least one attachment device in communication with the at least one attachment mechanism, positioning the at least one attachment mechanism between the collar and the pet, encircling the collar with the at least one attachment mechanism, and actuating the at least one attachment device in communication with the at least one attachment mechanism to detachably couple the safety device to the collar.

Other objects and further features of the present invention will become apparent from the following detailed description when read in conjunction with the attached drawings.

### BRIEF DESCRIPTION OF THE DRAWINGS

The apparatus of the present invention will be explained in more detail by way of the accompanying drawings, wherein:

FIG. 1 is an elevated side view of an embodiment of the present invention;

FIG. 2 is a perspective view of an embodiment of the present invention; and

FIG. 3 is a detailed view of an embodiment of the attachment mechanism of the present invention.

### DETAILED DESCRIPTION OF THE INVENTION

Disclosed herein is a detailed description of various illustrated embodiments of the present invention. This description is not to be taken in a limiting sense, but is made merely for the purpose of illustrating the general principles of the invention.

The present invention is directed to a safety device which is easily attachable to and removable from an existing pet collar. More particularly, the present invention enables the operator to easily apply the present invention to the existing collar of a pet without modification of the collar or without any tools or other devices. In addition, the present invention may be easily adapted to display a plurality of designs, patterns, messages, slogans, or other decorations as desired. As those skilled in the art will appreciate, the present invention is simple and inexpensive to manufacture and may be manufactured from a plurality of materials, in a variety of shapes, patterns, and sizes as desired.

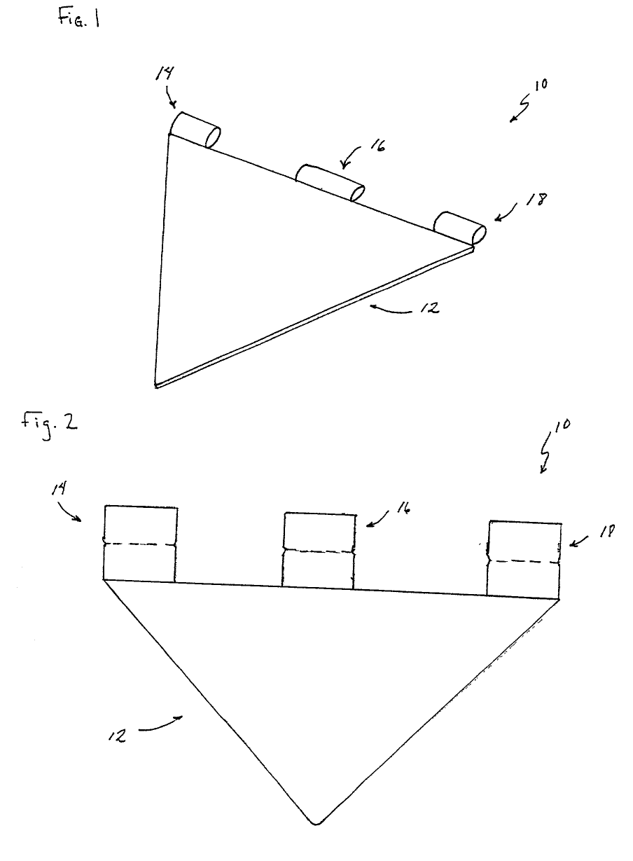

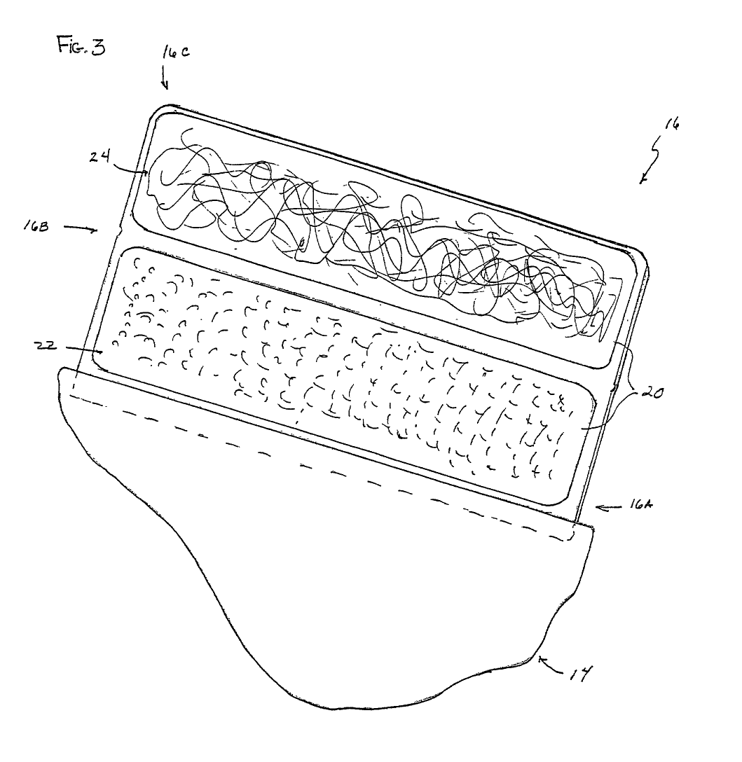

The present invention discloses an attachable safety device having a device body and at least one attachment mechanism attached thereto or in communication therewith. FIGS. 1 and 2 show the safety device 10 having a device body 12 and three attachment mechanisms 14, 16, and 18 attached thereto. The device body 12 may be manufactured from a plurality of materials including, without limitation, cotton, denim, polyester, nylon, canvas, wool, fleece, or any other suitable fabric. In an alternate embodiment, the device body may include light reflecting material thereon of integrated therein, thereby providing enhanced visibility at night or in other low-light situations. The device body 12 may be adapted to provide a display surface or otherwise being capable of receiving a design or pattern thereon. For example, the device body 12 may be capable of receiving printed messages, permanent dyes, stamped messages, pictures, and embroidered or sewn patches thereon. It should be understood FIG. 1 illustrates one embodiment of the present invention wherein the device body 12 comprises a triangular shape. Those skilled in the art will appreciate that the present invention may be manufactured in a plurality of shapes, including, without limitation, squares, rectangles, circles, pentagons, diamonds and other desired shapes. For example, the device body 12 may form a design, pattern, or slogan as desired. As shown in FIGS. 1 and 2, the attachment mechanisms 14, 16, and 18, respectively, may be attached to the device body 12 in a plurality of ways, including, for example, sewed, riveted, or adhesively attached. In an alternate embodiment, the at least one attachment mechanism may be formed in or integrally formed by the device body 12. Like the device body 12, the at least one attachment mechanism may be constructed from a plurality of materials including, without limitation, cotton, denim, polyester, nylon, canvas, wood, fleece, or any other suitable fabric, may incorporate light reflecting materials therein or thereon, and may be adapted to receive a design or pattern thereon.

FIG. 3 shows a detailed view of the at least one attachment mechanism of the present invention. As shown in FIG. 3, the at least one attachment mechanisms 16, may include a proximal portion 16a permanently attached to the device body 12, a medial portion 16b disposing a medial fold, and a distal portion 16c. At least one attachment device 20 may be positioned on the at least one attachment mechanism 16. As shown in FIG. 3, the at least one attachment device 20 may comprise a first portion 22 on or proximal to the proximal portion 16a of the at least one attachment mechanism 16. Similarly, a second portion 24 of the at least one attachment device 20 may be position on or proximal to the distal portion 16c of the at least one attachment mechanism 16.

As shown in FIG. 3, one embodiment of the present invention uses hook and loop material to detachably attach present invention to the existing collar of the animal. The proximal portion 22 of the at least one attachment device 20 may comprise the hook portion of the hook and loop material, while the distal portion 16c of the at least one attachment mechanism 16 may dispose the loop portion of the hook and loop material, or visa versa. The medial fold formed on the medial portion 16b of the at least one attachment mechanism 16 facilitates the interaction of the proximal portion 16a and the distal portion 16c. Those skilled in the art will appreciate that a plurality of attachment devices may be used to attach the present invention to the existing pet collar, including, without limitation, buttons, snaps, loops, ties, toggles, links, hooks, clasps, or other equivalent structures.

The present invention further discloses a method of attaching the present invention to the existing pet collar positioned on a pet. To attach the safety device to the existing collar of a pet, the user disengages the first portion 22 of the attachment device 20 from the second portion 24. The safety device 10 is positioned on the pet proximate to the attached collar. Thereafter, the distal portion, for example 16c, of at least one attachment mechanism, for example 16, having the second portion 24 of the attachment device 20 positioned thereon is positioned between the existing pet collar and the pet wherein the at least one attachment mechanism 16 is made to encircle the pet collar and wherein the pet collar is located proximate to the medial fold located on the medial portion, for example 16b. Thereafter, the second portion 24 of the attachment device 20 is made to re-engage the first portion 22, thereby resulting in the safety device 10 being detachably coupled to the existing pet collar. To remove the safety device 10 from the pet the user disengages the second portion 24 of the attachment device 20 from the first portion 22 and gently pulls the device body 14 away from the collar.

In closing it is understood that the embodiments of the invention disclosed herein are illustrative of the principles of the invention. Other modifications may be employed which are within the scope of the invention; thus, by way of example but not of limitation, alternative attachment mechanism devices, alternative device body materials and alternative device body shapes. Accordingly, the present invention is not limited to that precisely as shown and described in the present invention.

What is claimed is:

1. An attachable safety device capable of attaching to the collar of a pet, comprising:
a body member;
at least one attachment mechanism in communication with said body member; and
at least one attachment device in communication with said at least one attachment mechanism.

2. The apparatus of claim 1 wherein said body member is manufactured from at least one material selected from the group consisting of cotton, denim, polyester, nylon, canvas, wool, and fleece.

3. The apparatus of claim 1 wherein said body member comprises light-reflecting material.

4. The apparatus of claim 1 wherein said body member is manufactured in a shape selected from the group consisting of a square, rectangle, circle, pentagon, and diamond.

5. The apparatus of claim 1 wherein said body member comprises at least one design located thereon.

6. The apparatus of claim 5 wherein said at least one design is selected from the group consisting of printed messages, sewn patches, embroidered designs, and pictures.

7. The apparatus of claim 6 wherein said at least one design incorporates light-reflecting material therein.

8. The apparatus of claim 1 wherein said at least one attachment mechanism is selected from the group consisting of flaps, tabs, button holes, rings, and releasable fasteners.

9. The apparatus of claim 1 wherein said at least one attachment mechanism is manufactured from at least one material selected from the group consisting of cotton, denim, polyester, nylon, canvas, wool, and fleece.

10. The apparatus of claim 1 wherein said at least one attachment mechanism further comprises light-reflecting material.

11. The apparatus of claim 1 wherein said at least one attachment mechanism is integrally formed in said body member.

12. The apparatus of claim 1 wherein said at least one attachment mechanism is coupled to said body member.

13. The apparatus of claim 1 wherein said at least one attachment device is selected from the group consisting of hook and loop materials, buttons, snaps, loops, ties, toggles, links, hooks, and clasps.

14. An attachable safety device capable of attaching to the collar of a pet, comprising:
a body member capable of receiving a design thereon;
at least one attachment mechanism in communication with said body member; and
at least one attachment device in communication with said at least one attachment mechanism.

15. The apparatus of claim 14 wherein said body member is manufactured from at least one material selected from the group consisting of cotton, denim, polyester, nylon, canvas, wool, and fleece.

16. The apparatus of claim 14 wherein The apparatus of claim 1 wherein said body member is manufactured in a shape selected from the group consisting of a square, rectangle, circle, pentagon, and diamond.

17. The apparatus of claim 14 wherein said design incorporates light-reflecting material therein.

18. A method of attaching a safety device to a collar of a pet, comprising:
positioning said collar on said pet;
providing a safety device having a body member, at least one attachment mechanism in communication with said body member, and at least one attachment device in communication with said at least one attachment mechanism;
positioning said at least one attachment mechanism between said collar and said pet;
encircling said collar with said at least one attachment mechanism; and
actuating said at least one attachment device in communication with said at least one attachment mechanism to detachably couple said safety device to said collar.
